(19) United States
(12) Patent Application Publication
(10) Pub. No.: US 2025/0123184 A1
(43) Pub. Date: Apr. 17, 2025

(54) SYSTEM AND METHOD FOR EVALUATING VEHICLE AXLE DIFFERENTIALS

(71) Applicant: BPG Sales and Technology Investments, LLC, Ada, MI (US)

(72) Inventors: Jon D. Lawrence, Corvallis, OR (US); Landon W. Potts, Ada, MI (US)

(21) Appl. No.: 18/914,762

(22) Filed: Oct. 14, 2024

Related U.S. Application Data
(60) Provisional application No. 63/589,756, filed on Oct. 12, 2023.

(51) Int. Cl. G01M 17/007; G01M 13/021; G01M 13/028

(52) U.S. Cl. CPC G01M 17/0072; G01M 13/021; G01M 13/028

(57) ABSTRACT

A system and method of evaluating a vehicle differential assembly on a vehicle includes positioning the vehicle on the test stand, where the test stand includes rollers for receiving wheel assemblies of the vehicle, rotating a first wheel assembly of the vehicle on the test stand to impart a differential rotation of the first wheel assembly relative to a second wheel assembly of the vehicle, and evaluating a differential assembly disposed between the first wheel assembly and the second wheel assembly. The second wheel assembly may be opposed on the opposite side of the vehicle from the first wheel assembly, and the rotating may include rotating the first wheel assembly at a different rotational speed than the second wheel assembly.

### CROSS REFERENCE TO RELATED APPLICATION

The present application claims the priority benefit of U.S. provisional patent application Ser. No. 63/589,756, filed on Oct. 12, 2023, which is hereby incorporated herein by reference in its entirety.

### BACKGROUND AND FIELD OF THE INVENTION

The present invention is directed to a system and method for evaluating differentials of a vehicle, and in particular to detect mechanical failures in differentials using a test stand.

Vehicle differentials are part of the powertrain of a vehicle and are used to distribute power from the engine to the wheel assemblies of the vehicle. Depending on the configuration, a vehicle may have one or more differentials. As with other vehicle powertrain components, differentials are subject to wear, damage and/or breakdown.

### SUMMARY OF THE INVENTION

The present invention provides a system and method for evaluating differential assemblies of a vehicle by enabling or allowing one or more wheel assemblies to be rotated at different rotational speeds than other wheel assemblies via a test stand. In an embodiment configured for evaluating an all-wheel drive (“AWD”) vehicle, front and rear wheel assemblies on one side of the vehicle may be rotated at different rotational speeds than the front and rear wheel assemblies on the opposite side of the vehicle to evaluate the differential assemblies disposed between the front wheel assemblies and the rear wheel assemblies.

According to an aspect of the present invention, a method of evaluating a vehicle differential assembly on a vehicle includes positioning a vehicle on a test stand, where the test stand comprises rollers for receiving wheel assemblies of the vehicle, rotating a first wheel assembly of the vehicle on the test stand to impart a differential rotation of the first wheel assembly relative to an opposed second wheel assembly of the vehicle, and evaluating a differential assembly disposed between the first wheel assembly and the second wheel assembly.

In a particular embodiment the rotating may include rotating the first wheel assembly at a different rotational speed than the second wheel assembly. The method may further comprise rotating a third wheel assembly of the vehicle on the test stand to impart a differential rotation of the third wheel assembly relative to an opposed fourth wheel assembly of the vehicle, where the evaluating further comprises evaluating another differential assembly disposed between the third wheel assembly and the fourth wheel assembly. In such a configuration the first wheel assembly may be a front left wheel assembly, the second wheel assembly may be a front right wheel assembly, and the differential assembly comprises a front differential assembly, and the third wheel assembly may be a rear left wheel assembly, the fourth wheel assembly may be a rear right wheel assembly, and the other differential assembly comprises a rear differential assembly. In such a configuration the method may involve rotating the front left wheel assembly and the rear left wheel assembly at a slower rotational speed than the front right wheel assembly and the rear right wheel assembly to simulate a left turn. The method may further involve rotating the front left wheel assembly and the rear left wheel assembly at a faster rotational speed than the front right wheel assembly and the rear right wheel assembly to simulate a right turn.

The wheel assemblies of the vehicle may be driven to import rotation to the rollers of the test stand, and/or the wheel assemblies of the vehicle may be driven by the rollers of the test stand.

Evaluating the differential assemblies may be conducted by evaluating sounds and/or vibrations from the differential assembly, and/or by evaluating a differential assembly using sensors.

According to a further aspect of the present invention, a method of evaluating a vehicle differential assembly on a vehicle includes positioning a vehicle on a test stand, where the test stand comprises rollers for receiving wheel assemblies of the vehicle, rotating a first pair of opposed wheel assemblies of the vehicle on the test stand at a first rotational speed that is different than a rotational speed of a second pair of opposed wheel assemblies to impart a differential rotation at a differential assembly disposed between the first and second pair of opposed wheel assemblies, and evaluating the differential assembly disposed between the first and second pair of wheel assemblies. In a particular embodiment the method comprises rotating the second pair of opposed wheel assemblies at either a faster or a slower rotational speed than the first pair of opposed wheel assemblies.

In a still further aspect of the invention, a system for evaluating a vehicle differential assembly on a vehicle comprises a test stand comprising rollers for receiving wheel assemblies of a vehicle, and a computer control, where the test stand is configured to enable or allow at least one the wheel assemblies of the vehicle to be rotated at a different rotational speed than another wheel assembly of the vehicle for evaluation of a vehicle differential assembly of the vehicle. In a particular embodiment, the computer control is configured to selectively enable or allow the wheel assemblies of the vehicle to be rotated at different rotational speeds. In a further particular embodiment, the test stand enables or allows a wheel assembly on one side of the vehicle to be rotated at a different rotational speed than a corresponding wheel assembly on the opposite side of the vehicle for evaluating a differential assembly disposed there between. Still further, the test stand may be configured to enable front and rear wheel assemblies on one side of the vehicle to be rotated at different rotational speeds than corresponding front and rear wheel assemblies on the opposite side of the vehicle for evaluating differential assemblies disposed between the front wheel assemblies and between the rear wheel assemblies.

Optionally the evaluating of the differentials may be done while the vehicle engine is turned off.

Still further, evaluating differentials may be done by monitoring torque via a test stand. For example, torque differences required to rotate wheel assemblies relative to one or more of the individual ones of the wheel assemblies may be monitored. This may include, for example, monitoring the torque required to maintain a delta in the wheel speeds by rollers of the test stand, such as on a given axle.

The test system and method may also impart a differential speed over a predetermined time. This may be, for example, a percentage change in rotational speed over a predetermined time range.

Still further, evaluating differentials may comprise placing a vehicle in park to lock the drive-train and then applying a roll speed to one or more of the wheel assemblies and measuring the torque required to drive the one or more wheel assemblies. This may include, for example, ramping up the applied torque to establish a break-away speed and/or torque value at which the differential assembly begins to breakaway and slip.

In yet a further embodiment, a differential assembly may be evaluated by driving a vehicle to a speed on the test stand and evaluating whether the differential assembly maintains matching rotational speed of a corresponding wheel assembly associated with the differential assembly. Alternatively, torque may be imparted via the test stand to one of the wheel assemblies resulting in the wheel assembly being driven at a particular speed, where other of the wheel assemblies may be monitored to determine if they maintain matching rotational speeds.

In still a further embodiment, a differential may be evaluated by being locked and then released and monitored to determine the rate at which it accelerates to a given speed. This may include via the vehicle driving another wheel associated with the differential or by the test stand applying torque to the another wheel associated with the differential.

In yet a further embodiment, wheel assemblies associated with a given differential may be caused to rotate in opposite directions, such as via the test stand. That is, one may be driven to rotate in a forward driving direction of the vehicle while the other is driven to rotate in a reverse driving direction of the vehicle.

The present invention provides a cost effective and convenient evaluation system and method for evaluating vehicle differential systems without having to drive the vehicle on a road. The system also enables consistent test parameters to be employed to thereby impart objective evaluation criteria to the evaluation. These and other objects, advantages, purposes and features of this invention will become apparent upon review of the following specification in conjunction with the drawings.

### BRIEF DESCRIPTION OF THE DRAWINGS

FIG. 1 is a perspective view of an all-wheel drive (“AWD”) vehicle disposed on a test stand for evaluation;

FIG. 2 is a side elevation of the vehicle and test stand of FIG. 1;

FIG. 3 is a schematic top plan view of the drivetrain of the vehicle of FIG. 1;

FIG. 4 is a computer control device for operation of the test stand of FIG. 1;

FIG. 5 is a schematic flow diagram of an evaluation process in accordance with aspects of the present invention.

### DESCRIPTION OF THE PREFERRED EMBODIMENTS

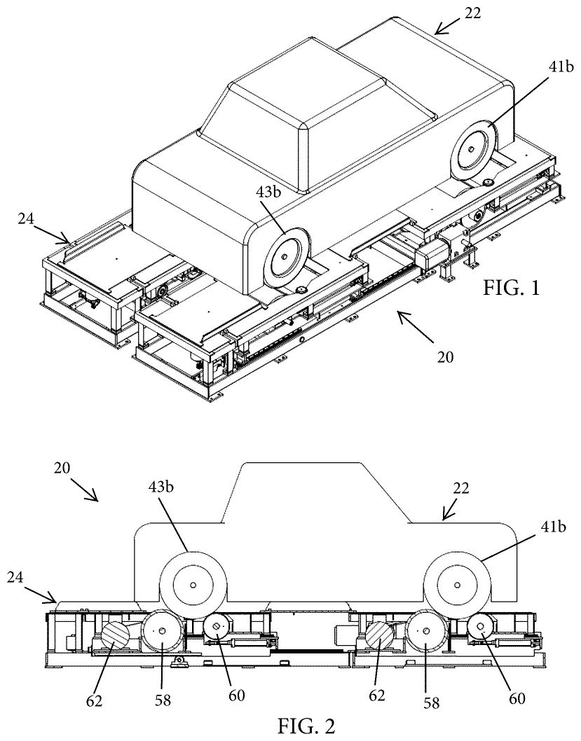

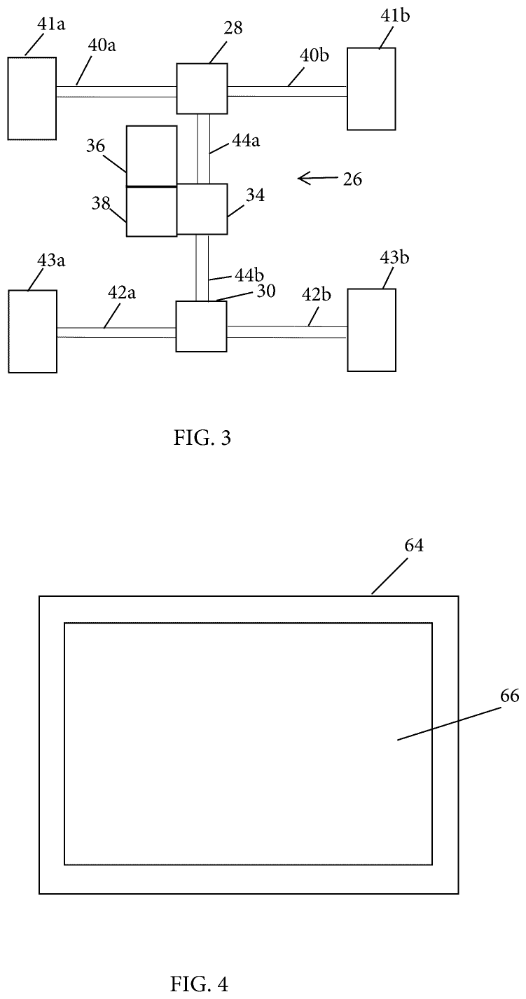

The present invention will now be described with reference to the accompanying figures, wherein the numbered elements in the following written description correspond to like-numbered elements in the figures. FIGS. 1 and 2 illustrate a system 20 for evaluating a vehicle 22 on a test stand 24 in accordance with aspects of the present invention, and in particular with reference to FIG. 3 for evaluating components of the drivetrain 26 of vehicle 22, including a front differential assembly 28, a rear differential assembly 30 and a center differential assembly 34, where vehicle 22 additionally includes an engine 36 and transmission 38. As discussed in more detail below, test stand 24 enables operation of vehicle 22 on test stand 24, including to simulate turning operations of vehicle 22 to thereby detect mechanical failures in differential assemblies 28 and 30, as well as enables operation of vehicle 22 to detect mechanical failures in center differential assembly 34.

Vehicle 22 in the illustrated embodiment is an all-wheel drive (“AWD”) vehicle in which in addition to front and rear differential assemblies 28, 30, the drivetrain 26 includes front axles 40a, 40b and rear axles 42a, 42b, where front differential assembly 28 is configured to distribute power to front axles 40a, 40b for driving front wheel assemblies 41a, 41b and rear differential assembly 30 is configured to distribute power to rear axles 42a, 42b for driving rear wheel assemblies 43a, 43b. Center differential assembly 34, in turn, receives power from engine 36 via transmission 38 for distributing power to the front and rear differentials 28, 30 via driveshafts 44a, 44b. The front and rear differential assemblies 28, 30 may comprise or include various differential components, including limited slip differential (“LSD”) clutches, viscous couplings, as well as other alternative differential types and configurations.

As understood from FIGS. 1 and 2, test stand 24 is configured as a roll-brake stand having pairs of rollers 58, 60 that rotationally support front and rear tire and wheel assemblies 41a, 41b and 43a, 43b. Vehicle 22 is configured to be operated on stand 24 such that drivetrain 28 drives one or more of rollers 58, 60, where the rollers 58, 60 may provide rolling resistance and/or assistance to the driven wheels 41a, 41b, 43a, 43b of vehicle 22 strictly via inertial resistance, or alternatively, electric motors 62 coupled with rollers 58 of stand 24 may be employed to provide additional resistance or assistance to driven wheels of vehicle 22, as discussed below. Stand 24 may additionally include brakes for rollers 58 and/or 60 that may alternatively or additionally be used to provide rolling resistance. Although stand 24 is shown in the illustrated embodiment as having four pairs of rollers 58, 60 for each of the wheel assemblies 41a, 41b, 43a, 43b of vehicle 22, it should be appreciated that an alternatively configured stand may have fewer such pairs of rollers, such as two forward sets for a front wheel drive vehicle. It should further be appreciated that alternatively configured and arranged roll brake stands or dynamometers may be employed within the scope of the present invention.

In one embodiment, vehicle 22 is tested by an operator or driver or technician sitting in vehicle 22 while on test stand 24, with the operator depressing the vehicle throttle (accelerator pedal) by foot action, such as under guidance or direction by a computer control system, which in the illustrated embodiment comprises a computer control device or controller 64. The operating of vehicle 22 on test stand 24 causes wheel assemblies 41a, 41b, 43a, 43b to drive the associated respective rollers 58, 60 of test stand 24 to thereby impart torque through the drivetrain 26, as if the vehicle 22 were being operated on a road. While operating vehicle 22 on test stand 24, the operator is able to provide control signals to test stand 24 via computer device 64 for simulating a turn with vehicle 22. For example, test stand 24 may selectively cause front and rear wheel assemblies on one side of vehicle 22 to rotate at a slower speed than the front and rear wheel assemblies on the opposite side of vehicle 22, which thereby establishes relative motion in the front and rear differential assemblies 28, 30 that would otherwise remain in a static condition when the vehicle is driving straight. This relative motion in the front and rear differential assemblies 28, 30 thus simulates the driving of vehicle 22 as if it were turning either left or right depending on whether the left side wheel assemblies 41a, 43a or the right side wheel assemblies 41b, 43b are caused to rotate at a slower speed. During the simulated turning operation the operator may listen for audible noises from the front and rear differential assemblies 28, 30 to evaluate whether or not there is a mechanical failure in one or both of the assemblies. Alternatively, one or more noise, vibration and harshness (“NVH”) sensors may be employed for evaluating whether or not there is a mechanical failure in one or both of the assemblies, such as, for example, vibration sensors or accelerometers, or noise sensors or microphones.

With reference to FIG. 4, in the illustrated embodiment computer device 64 comprises a handheld tablet computer having a screen 66, where computer device 64 may be operatively connected with test stand 24, such as to a computer or controller of test stand 24, by a wireless or wired connection. Computer device 64 comprises one or more programs that are configured to provide instructions or prompts or directions to the operator of vehicle 22 for testing. Computer device 64 may alternatively include one or more programs to provide control signals to test stand 24 for operating test stand 24 in a desired testing format without requiring prompts or requiring fewer prompts to an operator.

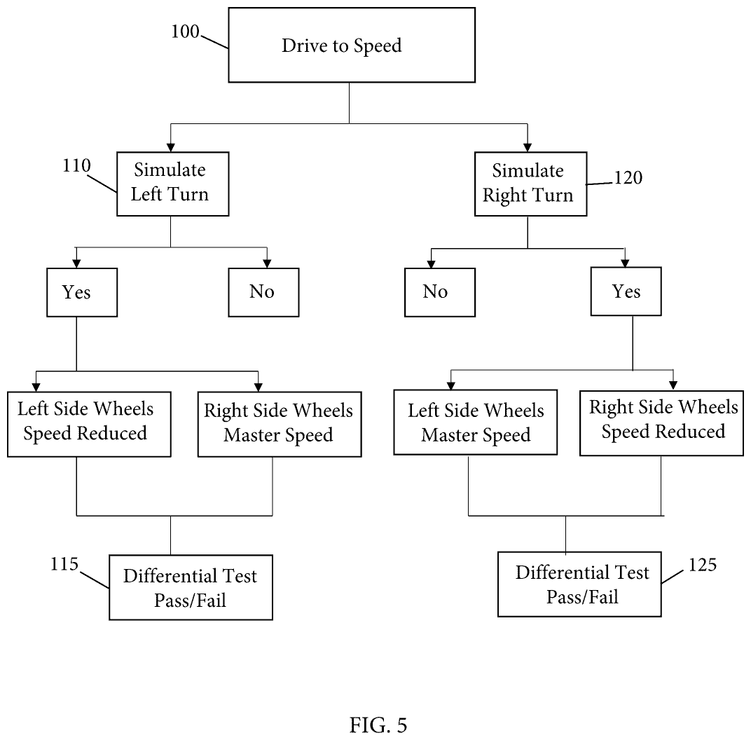

For example, with reference to FIG. 5, an exemplary evaluation process is illustrated in which the operator drives vehicle 22 onto test stand 24 and then initiates an evaluation procedure. Computer device 64 may initially prompt the operator to drive to an initial speed, which may be a preset speed or range. In a particular embodiment the evaluation procedure is intended to simulate a slow speed, tight turn whereby the initial speed may be in the range of 5 mph, plus or minus one to three miles per hour. The reaching of the desired or set initial speed at step 100, which may be preset or predetermined, may be established by the operator viewing the vehicle speedometer or may be provided by test stand 24 based on the rotation of rollers 58, 60. For example, operator may enter information regarding vehicle 22 into computer device 64 prior to initiating testing, such as the tire size and/or the make, model and/or year of vehicle 22 whereby system 20 is able to determine and monitor the speed of vehicle 22 via the rotation of rollers 58, 60.

Upon reaching the desired speed, computer device 64 may prompt the operator to simulate a left turn, as shown at step 110, or simulate a right turn, as shown at step 120, or alternatively allow the operator to select between simulating a left or right turn. With regard to simulating a left turn, the operator may be able to select between “yes” or “no” to initiate the simulation, where the selection of “no” would stop the test process. Upon selecting “yes”, the initial speed at step 100 is taken or establishes a master speed. For the left turn simulation, the right side wheel assemblies 41b, 43b are maintained at the master speed and the rollers 58, 60 associated with the left side wheel assemblies 41a, 43a impart a speed reduction to the left side wheel assemblies 41a, 43a. For example, the speed reduction may be preset and be in the range of a 19 percent reduction from the master speed, plus or minus a few percent. Test stand 24 may impart resistance to one or more of rollers 58, 60 on the left side of test stand 24 to increase the rolling resistance to the left side front and rear wheel assemblies 41a, 43a. For example, electric motors 62 coupled with rollers 58 of stand 24 may be employed to provide additional resistance to the left side front and rear driven wheels 41a, 43a. Alternatively, the left side wheel assemblies 41a, 43a may be maintained at a given speed and the speed of the right side wheel assemblies 41b, 43b increased such as by additional rolling assistance imparted by test stand 24.

Correspondingly, for the right turn simulation, the left side wheel assemblies 41a, 43a are maintained at the master speed and the rollers 58, 60 associated with the right side wheel assemblies 41b, 43b impart a speed reduction to the right side wheel assemblies 41b, 43b. For example, the speed reduction may again be preset and be in the range of a 19 percent reduction from the master speed, plus or minus a few percent. Test stand 24 may impart resistance to one or more of rollers 58, 60 on the right side of test stand 24 to increase the rolling resistance to the right side front and rear wheel assemblies 41b, 43b. For example, electric motors 62 coupled with rollers 58 of stand 24 may be employed to provide additional resistance to the right side front and rear driven wheels 41b, 43b. Alternatively, the right side wheel assemblies 41b, 43b may be maintained at a given speed and the speed of the left side wheel assemblies 41a, 43a increased such as by additional rolling assistance imparted by test stand 24.

As noted, the operator of vehicle 22 may listen for mechanical failures in the front and rear differential assemblies 28, 30 during the left and right turning simulations, where a mechanical failure may be disclosed by unusual noises heard by the operator or vibrations felt by the operator in the vehicle 22, such as through the steering wheel or floor of vehicle 22. Accordingly, computer device 64 may provide one or more prompts or inquiries to the operator to indicate whether or not the vehicle 22 under test passed the evaluation, such as shown at steps 115 and 125, where the operator is able to indicate whether the vehicle 22 passed or failed the evaluation. The operator may have previously entered data, such as using computer device 64, regarding the vehicle 22, such as the vehicle identification number (“VIN”), license plate, or the like, whereby the result of the evaluation is associated with the specific vehicle 22. Although shown in the illustrated embodiment as providing an operator with an opportunity to enter a pass or fail evaluation after both a left turn and a right turn, it should be appreciated that system 20 may alternatively provide a single data entry after both a left and a right turn has been completed. Alternatively, one or more sensors may be affixed and/or directed to vehicle 22 prior to testing, such as to detect structure-borne vibrations of the differential assemblies 28, 30 and/or sound energy of noises of the differential assemblies 28, 30, with the sensors providing signals to system 20. Such sensors may include a non-contact sensor such as a laser vibrometer, accelerometer, microphone, or the like. System 20 may be configured to evaluate the sensor signals, such as against or relative to a known correctly operating vehicle, with system 20 thereby providing a computer automated evaluation as to whether or not the vehicle 22 under test passes the evaluation. That is, data from such sensors 20 may be compared to a predetermined acceptable limit or value of the parameter detected by the sensor 20. For example, this may be a predetermined vibration limit and/or a predetermined noise limit.

Upon completion of the evaluation, system 20 may provide additional prompts or enable entry of further commands via computer device 64, such as to instruct the operator of vehicle 22 to apply the vehicle brakes to stop rotation of the wheel assemblies 41a, 41b, 43a, 43b and to stop test stand 24. Test stand 24 may then lock or fix rollers 58, 60 to enable the operator to drive vehicle 22 off the test stand 24.

During evaluation, vehicle 22 and test stand 24 may be operated to maintain, within operating ability, the same average speeds for front axles 40a, 40b and rear axles 42a, 42b, so as to avoid exercising or to eliminate action or interaction by center differential assembly 34. To this end, the speeds of rollers 58, 60 of test stand 24 may be controlled to maintain equal average speeds of the front axles 40a, 40b and rear axles 42a, 42b.

It should be appreciated that various alternative test stand configurations and evaluation methodologies may be employed within the scope of the present invention, and including for use with alternatively configured vehicles. For example, if a vehicle is not full-time all-wheel drive, a single-axle variant of this test may be employed. This may include a test stand that only has rollers at the driven wheels of the vehicle, or may comprise a test stand 24 such as described above but for which certain rollers 58, 60 engaged with non-driven wheels of the vehicle are not utilized during the evaluation.

As noted, test stand 24 may provide a resisting torque to one or more of the drive axles 40a, 40b, 42a, 42b to increase the load on the drivetrain components, which may expose additional NVH qualities. Additionally, it may increase the pinion-to-side gear load resulting in an increase in clutch torque-transmission effectiveness. Still further, in order to isolate the NHV issues from either front axles 40a, 40b or rear axles 42a, 42b, the differential wheel speeds may be established only on one axle, while equal wheel speeds are established on the other axle. For example, rather than decreasing the speed of both the left front and rear wheel assemblies 41a, 43a in the left turn simulation discussed above, either one or the other of the left front and rear assemblies 41a, 43a may be decreased to thereby impart differential speed to the associated one of the front differential assembly 28 or rear differential assembly 30. It should be appreciated that the evaluation may prompt the operator to cycle through a process whereby the rotational speed of all four wheel assemblies 41a, 41b, 43a, 43b are individually reduced.

The vehicle engine 36 may also be turned off with the test stand 24 establishing the relative wheel assembly speeds in order to reduce ambient noise and improve the ability of an operator or sensors to identify NVH issues.

In a further evaluation, the center differential assembly 34 may be exercised with a similar method in an attempt to induce NVH conditions on the components of the center differential assembly 34. For example, the front wheel assemblies 41a, 41b may be operated at a same first speed and the rear wheel assemblies 43a, 43b may be operated at a same second speed that is different from the first speed.

Still further, a locked differential assembly, which may have been inadvertently selected by the operator or result from a defective differential assembly, may be detected by monitoring the torque required to maintain the delta wheel speeds by rollers of test stand 24 on an axle. This evaluation may establish either an incorrectly locked or un-locked differential. Torque may be measured using stand 24 via rollers 58 and/or 60, such as associated with the force required for rotation of one or both rollers and provided to controller 64.

The evaluation may also impart a differential speed over a predetermined time in the event that NVH qualities of a differential assembly present differently at different relative wheel speed splits. When test stand 24 is signaled to simulate a left turn by decreasing the rotational speed of left front and rear wheel assemblies 41a, 43a by the preset reduction, test stand 24 may do so over a set period of time. The reduction may be applied in a sweep, such as a percentage decrease over a period of time. This may be, for example, 0 to 19 percent over five seconds. Other such decreases and/or time periods may be employed.

The LSD differential assemblies are effectively configured or operate as a clutch between wheels on an axle. The effectiveness of the clutch mechanism may also be evaluated by locking the drive-train by placing the vehicle in park and commanding a nominal roll speed via test stand 24 to drive one or more or all of the wheel assemblies 41a, 41b, 43a, 43b. The torque required to drive a wheel assembly is then representative of the clutch capability of the differential assembly. A still further possible evaluation technique may be to slowly ramp torque applied to a wheel assembly 41a, 41b, 43a, 43b using test stand 24 and establish the “break-away speed” at which the clutch action of the differential assembly begins to break free and begins to slip. In such a configuration, when driving one wheel assembly the corresponding opposite wheel assembly of the front or rear axle on the opposite side of the vehicle 22 must necessarily be free to rotate in order to evaluate the front or rear differential 28, 30 disposed between the wheel assemblies.

Still further, the effectiveness of a LSD differential assembly may be evaluated by driving the vehicle 22 to a low speed on test stand 24 and evaluating whether the differential assembly maintains matching rotational speeds of the corresponding wheel assemblies associated with the differential assembly. Similarly, an amount of roll torque may be introduced by test stand 24 to one of the wheel assemblies of vehicle 22 to establish that the differential assembly continues to maintain matching rotational speeds for the associated opposed wheel assemblies.

The effectiveness of a LSD wheel assembly may also be evaluated by the following process, such as for a rear-wheel drive vehicle: The test stand 24 holds the left-rear (LR) wheel assembly 43a at zero-speed; the operator accelerates to 5 MPH whereby the right-rear (RR) wheel assembly 43b accelerates; the left rear wheel assembly 43a remains at zero and the LSD differential assembly is in relative motion; the test stand 24 releases the left rear wheel assembly 43a such that it accelerates to 5 mph. The duration (rate) of the acceleration of the left rear wheel assembly 43a indicates the effectiveness of the LSD differential assembly.

In an alternative configuration of the above discussed evaluation methodology, the test stand 24 may be employed to impart rotation to a selected wheel assembly. For example, with a vehicle in neutral, the associated rollers 58, 60 of the test stand 24 may be commanded to maintain the left rear wheel assembly 43a to be maintained at 0 MPH and the associated rollers 58, 60 of the test stand 24 may be commanded to drive the right rear wheel assembly 43b to 5 MPH whereby the rear differential assembly 30 is in relative motion. The test stand 24 may then release the left rear wheel assembly 43a whereby it accelerates to 5 MPH. The duration (rate) of the acceleration of the left rear wheel assembly 43a may again indicate the effectiveness of the LSD differential assembly 30.

In a still further configuration for evaluating an LSD differential assembly and/or differential lock, the transmission 38 and center differential 34 may be locked and opposite front wheel assemblies 41a, 41b and/or opposite rear wheel assemblies 43a, 43b driven in opposite directions from each other. That is, for example, the left front wheel assembly 41a may be rotated by stand 24 in either a forward or rearward direction and the right front wheel assembly 41b rotated by stand 24 in the opposite direction from the left front wheel assembly 41a, i.e. either in a rearward or forward direction, for evaluation of the front differential 28. The same applies for the rear wheel assemblies 43a, 43b.

It should be appreciated that the methods described above may vary depending on the vehicle options, particularly drive-type (front-wheel drive, rear-wheel drive, all-wheel drive or part-time 4x4), axle differential and center differential types. Moreover, vehicle electronic control units (“ECUs”) may generate wheel-speed plausibility diagnostic trouble codes (“DTCs”) upon sensing wheel assemblies operating at different speeds. Test conditions may be employed to avoid such faults, such as by operating at sufficiently low speeds and durations. Alternatively and/or additionally, test-induced DTCs that are generated may be cleared by diagnostic commands and/or by driving on the road. It should further be appreciated that in the various above noted embodiments the evaluation may be based on, as discussed above, an operator listening for mechanical failures based on noises heard by the operator or vibrations felt by the operator, and/or may be based on the use of sensors that detect signals, such as structure-born vibrations and/or sound energy of noises, where the signals detected by the sensors may be compared to a predetermined acceptable limit or value.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A method of evaluating a vehicle differential assembly on a vehicle comprising:
positioning a vehicle on a test stand, wherein the test stand comprises rollers for receiving wheel assemblies of the vehicle;
rotating a first wheel assembly of the vehicle on the test stand to impart a differential rotation of the first wheel assembly relative to a second wheel assembly of the vehicle; and
evaluating a differential assembly disposed between the first wheel assembly and the second wheel assembly.

2. The method of claim 1, wherein the second wheel assembly is opposed on the opposite side of the vehicle from the first wheel assembly.

3. The method of claim 2, wherein said rotating comprises rotating the first wheel assembly at a different rotational speed than the second wheel assembly.

4. The method of claim 3, further comprising rotating a third wheel assembly of the vehicle on the test stand to impart a differential rotation of the third wheel assembly relative to an opposed fourth wheel assembly of the vehicle, and wherein said evaluating further comprises evaluating another differential assembly disposed between the third wheel assembly and the fourth wheel assembly.

5. The method of claim 4, wherein said rotating the third wheel assembly to impart a differential rotation of the third wheel assembly relative to the opposed fourth wheel assembly comprises rotating the first wheel assembly at a different rotational speed than the second wheel assembly.

6. The method of claim 5, wherein the first wheel assembly comprises a front left wheel assembly, the second wheel assembly comprises a front right wheel assembly, and the differential assembly comprises a front differential assembly, and wherein the third wheel assembly comprises a rear left wheel assembly, the fourth wheel assembly comprise a rear right wheel assembly, and the another differential assembly comprises a rear differential assembly.

7. The method of claim 6, wherein said method comprises rotating the front left wheel assembly and the rear left wheel assembly at a slower rotational speed than the front right wheel assembly and the rear right wheel assembly to simulate a left turn.

8. The method of claim 6, wherein said method comprises rotating the front left wheel assembly and the rear left wheel assembly at a faster rotational speed than the front right wheel assembly and the rear right wheel assembly to simulate a right turn.

9. The method of claim 1, wherein the wheel assemblies of the vehicle are driven by the vehicle to impart rotation to the rollers of the test stand.

10. The method of claim 1, wherein the wheel assemblies of the vehicle are driven by the rollers of the test stand.

11. The method of claim 1, wherein said evaluating comprises evaluating a differential assembly by sounds and/or vibrations from the differential assembly.

12. The method of claim 11, wherein said evaluating comprises evaluating sounds and/or vibrations from the differential assembly using sensors.

13. A method of evaluating a vehicle differential assembly on a vehicle comprising:
positioning a vehicle on a test stand, wherein the test stand comprises rollers for receiving wheel assemblies of the vehicle;
rotating a first pair of opposed wheel assemblies of the vehicle on the test stand at a first rotational speed that is different than a rotational speed of a second pair of opposed wheel assemblies to impart a differential rotation at a differential assembly disposed between the first and second pair of opposed wheel assemblies; and
evaluating the differential assembly disposed between the first and second pair of wheel assemblies.

14. The method of claim 13, wherein said rotating comprises rotating the second pair of opposed wheel assemblies at either a faster or a slower rotational speed than the first pair of opposed wheel assemblies.

15. The method of claim 13, wherein the wheel assemblies of the vehicle are driven by the vehicle to impart rotation to the rollers of the test stand or wherein the wheel assemblies of the vehicle are driven by the rollers of the test stand.

16. A system for evaluating a vehicle differential assembly on a vehicle, said system comprising:
a test stand, said test stand comprising rollers for receiving wheel assemblies of a vehicle; and
a computer control;
wherein said test stand is configured to enable or allow at least one the wheel assemblies of the vehicle to be rotated at a different rotational speed than another wheel assembly of the vehicle for evaluation of a vehicle differential assembly of the vehicle.

17. The system of claim 16 wherein said computer control is configured to selectively enable or allow wheel assemblies of the vehicle to be rotated at different rotational speeds.

18. The system of claim 16, wherein said test stand enables or allows a wheel assembly on one side of the vehicle to be rotated at a different rotational speed than a corresponding wheel assembly on the opposite side of the vehicle for evaluating a differential assembly disposed there between.

19. The system of claim 18, wherein said test stand enables front and rear wheel assemblies on one side of the vehicle to be rotated at a different rotational speed than corresponding front and rear wheel assemblies on the opposite side of the vehicle for evaluating differential assemblies disposed between the front wheel assemblies and between the rear wheel assemblies.
